(19) United States
(12) Patent Application Publication
(10) Pub. No.: US 2004/0037530 A1
(43) Pub. Date: Feb. 26, 2004

(54) Process for producing polymer optical waveguide

(75) Inventors: Shigemi Ohtsu, Nakai-machi (JP); Keishi Shimizu, Nakai-machi (JP); Kazutoshi Yatsuda, Nakai-machi (JP); Eiichi Akutsu, Nakai-machi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/461,340

(22) Filed: Jun. 16, 2003

(30) Foreign Application Priority Data
Jun. 27, 2002 (JP) 2002-187473
Mar. 5, 2003 (JP) 2003-058872

(51) Int. Cl. G02B 6/10

(52) U.S. Cl. 385/129

(57) ABSTRACT

A process for producing an optical waveguide is provided, the process containing the steps of: forming a layer of a resin material for forming a template on a master having protrusions for optical waveguides, releasing the layer to duplicate the master, and cutting both ends of the layer to expose depressions corresponding to the protrusions for optical waveguides as a template; closely contacting a film substrate having good adhesiveness to the template with the template; contacting one end of the template with an ultraviolet ray curable resin or a thermosetting resin to be a core, so as to fill the ultraviolet ray curable resin or the thermosetting resin in the depressions of the template by capillary phenomenon; curing the ultraviolet ray curable resin or the thermosetting resin thus filled, and releasing the template from the film substrate; and forming a clad layer on the film substrate.

### BACKGROUND OF THE INVENTION

1. Field of the Invention

The present invention relates to a process for producing an optical waveguide, particularly a flexible polymer waveguide.

2. Description of Related Art

As a process for producing a polymer waveguide, the following methods have been proposed, i.e., (1) a selective polymerization method, in which a film is impregnated with a monomer, a core part is selectively exposed to change the refractive index, and then the films are laminated; (2) an RIE method, in which a core layer and a clad layer are coated, and then a clad part is formed by reactive ion etching, (3) a direct exposing method, in which a photolithography method is employed, in which exposure and development are carried out by using an ultraviolet curable resin formed by adding a photosensitive material to a polymer material is used; (4) a method using injection molding; and (5) a photobleaching method, in which a core layer and a clad layer are coated, and then a core part is exposed to change the refractive index of the core part.

However, the selective polymerization method (1) has a problem in lamination of films; the methods (2) and (3) suffer increase in cost due to the use of the photolithography method; and the method (4) has a problem in accuracy of the diameter of the resulting core. The method (5) has such a problem in that a sufficient difference cannot be obtained in the refractive indexes of the core layer and the clad layer.

Only the methods (2) and (3) are currently available as a practical method providing excellent performance, but these have the problem described in the foregoing. Furthermore, no methods (1) to (5) can be applied to the production of a polymer waveguide on a flexible plastic substrate having a large area.

Another method for producing a polymer optical waveguide has also been known in that a polymer precursor material for a core is filled in a patterned substrate (clad) having a groove pattern to be capillaries and then cured to form a core layer, and a flat substrate (clad) is laminated thereon. In this method, the polymer precursor material is not only filled in the capillary grooves but also thinly formed on the allover interface between the patterned substrate and the flat substrate and then cured to form a thin layer having the same composition as the core layer, and as a result, there is such a problem that light is leaked from the thin layer.

In order to solve the problem, David Hart has proposed the following method. A patterned substrate having a groove pattern to be capillaries and a flat substrate are firmly fixed with a clamping jig, and the contact part of the patterned substrate and the flat substrate is sealed with a resin. Thereafter, a monomer (diallylisophthalate) solution is filled in the capillaries under reduced pressure, whereby a polymer optical waveguide (Japanese Patent No. 3,151,364) is produced. In this method, the viscosity of the material to be filled is lowered by using a monomer instead of the polymer precursor material as the resin material for forming the core, and the material is filled in the capillaries by utilizing the capillary phenomenon, whereby the monomer is filled only in the capillaries.

However, this method has such a problem that the monomer used as the material for forming the core suffers large volume contraction degree upon forming a polymer through polymerization of the monomer to increase the transmission loss of the polymer optical waveguide.

Furthermore, this method includes complicated operations, e.g., the patterned substrate and the flat substrate are firmly fixed by clamping, and the contact part thereof is sealed with a resin. Therefore, it is not suitable for mass production, and cost reduction cannot be expected thereby. This method also cannot be applied to the production of a polymer optical waveguide using a film having a thickness of several millimeters or less than 1 mm as a clad.

In recent years, George M. Whitesides of Harvard University has proposed a method referred to as capillary micromold, which is one application of softlithography as a new technology for forming nanostructures. In this method, a master substrate is produced by utilizing photolithography, and the nanostructures of the master substrate is duplicated to a template of polydimethylsiloxane (PDMS) utilizing the adhesiveness and the easy releasing property of PDMS. A liquid polymer is then filled in the template by utilizing the capillary phenomenon, followed by curing. Details of the method are disclosed in Scientific American, September of 2001 (Nikkei Science, December of 2001).

The capillary micromold method has been patented in the name of Kim Enoch, et al. as members of the group of George M. Whitesides (U.S. Pat. No. 6,355,198).

However, even though the production process disclosed in the patent is applied to production of a polymer optical waveguide, a prolonged period of time is required for forming the core part due to the small cross sectional area of the core part of the optical waveguide, and the method is not suitable for mass production Furthermore, the monomer solution causes volume change upon polymerization for forming a polymer to change the shape of the core, whereby such a problem is caused that the transmission loss is increased.

B. Michel, et al. of Zurich Laboratories, IBM, have proposed a high resolution lithography technique using PDMS, and have reported that a resolution in the order of several tens of nanometers can be obtained by the technique. Details of the technique are disclosed in IBM J. REV. & Dev., vol. 45, No. 5, September of 2001.

The softlithography technique and the capillary micromold method using PDMS are nanotechnologies receiving attention in the U.S.

However, in the production of an optical waveguide by the micromold method, it is impossible to realize both the small volume contraction degree upon curing (i.e., a low transmission loss) and the low viscosity of the liquid to be filled (e.g., a monomer) to facilitate charging. Therefore, in the case where the small transmission loss is preferentially considered, the viscosity of the liquid to be filled cannot be decreased beyond a certain limit to lower the charging speed, and therefore, mass production cannot be expected. Furthermore, the micromold method requires the use of a glass or silicone substrate as the substrate, but the use of a flexible film substrate is not considered

### SUMMARY OF THE INVENTION

The invention has been made in view of the foregoing problems associated with the conventional art and is to provide a process for producing a polymer optical waveguide in a simple method with low cost.

According to an aspect of the present invention, a process for producing a polymer optical waveguide includes the steps of: forming a layer of a resin material for forming a template on a master having protrusions for optical waveguides, releasing the layer to duplicate the master, and cutting both ends of the layer to expose depressions corresponding to the protrusions for optical waveguides, so as to produce a template; closely contacting a film substrate as a clad having good adhesiveness to the template with the template; contacting one end of the template with an ultraviolet ray curable resin or a thermosetting resin to be a core, so as to fill the ultraviolet ray curable resin or the thermosetting resin in the depressions of the template by capillary phenomenon; curing the ultraviolet ray curable resin or the thermosetting resin thus filled, and releasing the template from the film substrate; and forming a clad layer on the film substrate having cores formed thereon.

According to another aspect of the present invention, a process for producing a polymer optical waveguide includes the steps of: preparing a template formed from cured layer of curable resin, the template having a depression corresponding to a core portion of an expecting optical waveguide, an opening for filling a curable resin and an opening for expelling the curable resin; closely contacting a film substrate as a clad having good adhesiveness to the template with the template; contacting one end of the template with a curable resin to be a core, so as to fill the curable in the depression of the template by capillary phenomenon; curing the curable resin, and releasing the template from the film substrate; and forming a clad layer on the film substrate having cores formed thereon

### BRIEF DESCRIPTION OF THE DRAWINGS

A preferred embodiment of the invention will be described in detail based on the following figures wherein:

FIGS. 1A to 1G are conceptual cross sectional views showing examples of process steps of the process for producing a polymer optical waveguide according to the invention.

### DETAILED DESCRIPTION OF THE PREFERRED EMBODIMENTS

The process for producing a polymer optical waveguide according to the invention contains the following process steps:

(1) a process step, in which a layer of a resin material for forming a template is formed on a master having protrusions for optical waveguides and then released therefrom to duplicate the master, and both ends of the layer are cut to expose depressions corresponding to the protrusions for optical waveguides, so as to produce a template;

The template may separately be prepared with the following steps. The separately prepared template may be formed from cured layer of curable resin. The template may have a depression corresponding to a core portion of an expecting optical waveguide, an opening for filling a curable resin and an opening for expelling the curable resin.

(2) a process step, in which a film substrate for a clad having good adhesiveness to the template is closely contacted with the template;

(3) a process step, in which one end of the template having been closely contacted with the film substrate for a clad is contacted with an ultraviolet ray curable resin or a thermosetting resin to be a core, so as to fill the ultraviolet ray curable resin or the thermosetting resin in the depressions of the template by capillary phenomenon;

(4) a process step, in which the ultraviolet ray curable resin or the thermosetting resin thus filled is cured, and the template is released from the film substrate for a clad; and

(5) a process step, in which a clad layer is formed on the film substrate for a clad having cores formed thereon.

The process for producing a polymer optical waveguide according to the invention has been developed based on such a finding in that in the case where the film substrate for a clad having good adhesiveness to the template is closely contacted with the template, gaps between the template and the film substrate for a clad are formed only the depression structure formed in the template without any special operation for fixing them (e.g., the fixing operation disclosed in Japanese Patent No. 3,151,364), whereby an ultraviolet ray curable resin or a thermosetting resin can be filled only in the depressions. Therefore, the process for producing a polymer optical waveguide according to the invention is considerably simplified in process steps thereof and can easily produce a polymer optical waveguide, whereby a polymer optical waveguide can be produced in considerably low cost in comparison to the conventional processes for producing a polymer optical waveguide. Furthermore, according to the process for producing a polymer optical waveguide of the invention, such a flexible polymer optical waveguide can be obtained that has a small transmission loss and high accuracy and that can be freely applied to be installed in various kinds of instruments. Moreover, the shape of the polymer optical waveguide can be freely configured.

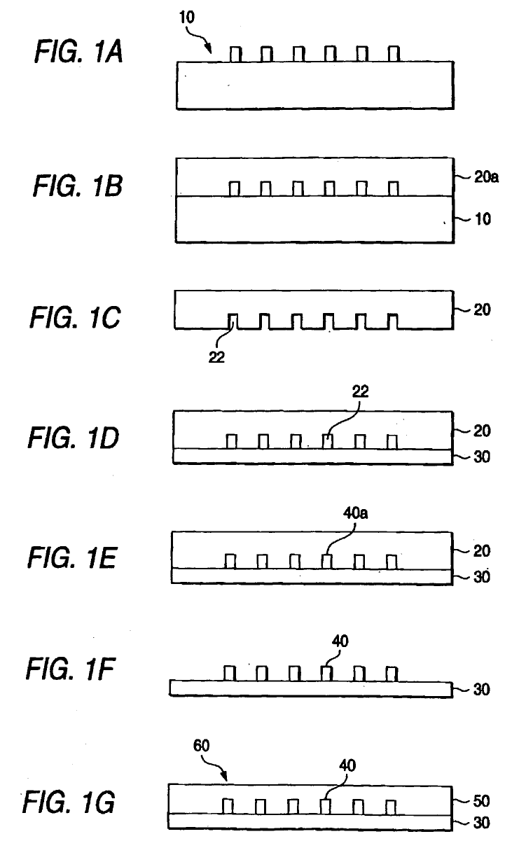

The process for producing a polymer optical waveguide of the invention will be schematically described with reference to FIGS. 1A to 1G.

FIG. 1A shows a master 10 having protrusions 12 for optical waveguides. As shown in FIG. 1B, a layer 20a of a resin material for forming a template (such as a cured layer of a curable resin) is formed on a surface of the master 10, on which the protrusions 12 for optical waveguides have been formed. The layer 20a of the resin material for forming a template is then released from the master 10 (duplication), and thereafter, both ends of the layer thus released are cut to expose depressions 22 corresponding to the protrusions 12 for optical waveguides (the cutting step not shown in the figures) to produce a template 20 as shown in FIG. 1C.

A film substrate 30 for a clad having good adhesiveness to the template is closely contacted with the template thus produced as shown in FIG. 1D. One end of the template is contacted with a curable resin 40a to be a core, whereby the resin is filled in the depressions 22 of the template by the capillary phenomenon. FIG. 1E shows such a state in that the curable resin has been filled in the depressions of the template. Thereafter, the curable resin in the depressions is cured, and the template is released (the process step not shown in the figures). As a result, protrusions 40 for the optical waveguide (core) are formed on the film substrate for a clad as shown in FIG. 1F.

A clad layer 50 is formed on the surface of the film substrate for a clad, on which the cores are formed, to complete a polymer optical waveguide 60 according to the invention as shown in FIG. 1G.

The process for producing a polymer optical waveguide of the invention will be described with reference to the respective process steps in sequence.

(1) The process step will be described, in which a layer of a resin material for forming a template is formed on a master having protrusions for optical waveguides and then released therefrom to duplicate the master, and both ends of the layer are cut to expose depressions corresponding to the protrusions for optical waveguides, so as to produce a template.

(Production of Master)

The conventional methods, such as the photolithography method, can be applied without limitation to the production of the master having protrusions for an optical waveguide (i.e., protrusions corresponding to the cores). Furthermore, the process for producing a polymer optical waveguide by an electrodeposition method or an optical electrodeposition method can also be applied to the production of the master, which process has been applied for patent by the inventors (Japanese Patent Laid-Open Publication No. 2002-333538). The size of the protrusions for an optical waveguide formed on the master is appropriately determined depending on the purpose of the polymer optical waveguide to be produced. For example, in the case of a single mode optical waveguide, cores having a square of about 10 μm are generally used, and in the case of a multimode optical waveguide, cores having a square of about from 50 to 100 μm are generally used. An optical waveguide having larger cores having a size of several hundreds Lm is also used in some cases.

(Duplication of Master)

The template is produced by forming a layer of a resin material for forming the template on the surface for the optical waveguide of the master thus produced and then released therefrom.

The resin material for forming the template preferably has such features that it can be easily released from the master, and it has a mechanical strength and a dimensional stability in a certain level or higher as a template for repeated use. The layer of the resin material for forming the template is formed with a resin for forming the template or a mixture of the resin and various additives depending on necessity.

Because it is necessary that the resin for forming the template accurately duplicates the respective optical waveguides formed on the master, it preferably has a viscosity of a certain limit or lower, for example about from 2,000 to 7,000 mPa·s. A solvent for adjusting the viscosity may be added for adjusting the viscosity in such an amount that no adverse affect due to the solvent is caused.

As the resin for forming the template, a curable silicone resin (e.g., a thermosetting type and a room temperature curing type) is preferably used from the standpoint of releasing property, mechanical strength and dimensional stability. A low molecular weight liquid resin of the resin is preferably used since sufficient permeability is expected. The viscosity of the resin is preferably from 500 to 7,000 mPa·s, and more preferably from 2,000 to 5,000 mpa·s.

As the curable silicone resin, those containing a methylsiloxane group, an ethylsiloxane group or a phenylsiloxane group are preferred and a curable dimethylsiloxane resin is particularly preferred.

It is also preferred that a releasing treatment, such as coating of a releasing agent, is previously effected on the master to facilitate release of the template.

Upon forming the layer of the resin material for forming the template on the optical waveguide surface of the master, the resin material for forming the template is coated or injected on the surface to form the layer of the resin for forming the template, and then the layer is subjected to a drying treatment or a curing treatment depending on necessity.

The thickness of the layer of the resin material for forming the template is appropriately determined under consideration of the handleability of the template, and in general, it is suitably about from 0.1 to 50 mm.

The layer of the resin material for forming the template and the master are then released from each other to obtain the template.

(Production of Template)

Both ends of the template are cut to expose the depressions formed on the template corresponding to the protrusions for forming optical waveguides to complete the template. The reason why the both ends of the template are cut to expose the depressions is that an ultraviolet ray curable resin or a thermosetting resin is penetrated into the depressions by the capillary phenomenon in the later step.

The surface energy of the template is preferably in a range of from 10 to 30 dyn/cm, and more preferably in a range of from 15 to 24 dyn/cm, from the standpoint of adhesiveness to the substrate film.

The share rubber hardness of the template is preferably in a range of from 15 to 80, and more preferably from 20 to 60, from the standpoint of performance in duplication and releasing property.

The surface roughness (root mean square roughness (RMS)) of the template is preferably 0.5 μm or less, and more preferably 0.1 μm or less, from the standpoint of performance in duplication.

The above mentioned process (1) may be replaced by the following steps.

(Production of Master)

The master may be produced by applying or inserting a curable resin for forming the master on the substrate having the protrusion thereon, curing the resin with or without heating or drying process, then the cured resin is released from the substrate. The producing method for forming a plural recess portions corresponding to the protrusion, one of the recess potion being a portion defining a hole for inserting a core formable curable resin and the other one of the recess portion being a potion defining a hole for repelling the inserted curable resin may not be specifically limited. Such protrusion defining the recess portions may previously formed onto the substrate, and as a simple process, for example, after applying the curable resin onto the substrate, releasing the cured resin therefrom and then the released cured resin, i.e. a master, is cut off at both side corresponding to the formed recess portion in order to forming the defining portions for defining the holes.

The thickness of the cured layer may preferably set from 0.1 to 50 mm. A releasing agent may previously applied onto the substrate for accelerating the releasing process.

As the cured resin for forming the master, in terms of easy releasing property or repeatedly used characteristics, such resins having a certain mechanical strength or stable size keeping property and a certain hardness capable of keeping their shape having a recess portion and a fitness to a film base for forming a crud layer may be used. Suitable additives may be added to the curable resin.

The curable resin may preferably having a viscosity form 500 to 700 mPa·S in terms of applicability on to the substrate or copying property for accurately copying the protrusion on the substrate. The cured resin includes a cured rubber. A certain solvent may be added to the resin for controlling the viscosity.

As such cured resin, curable organopolysiloxane capable of forming a silicone rubber or a silicone resin after the curing may preferably used. The organopoplysiloxane may preferably have a methylsiloxane group or ethylsiloxane group or phenylsiloxane group. The curable organopolysiloxane may be a single liquid type one or multiple liquid type with a curing materials. The cured resin may be thermal curing type or room-temperature curing type. In the present invention, such a curable organopolysiloxane for forming a cured silicone rubber after curing process may be preferable used. Also two-liquid type organopolysiloxane with a curing agent may preferably be used. Specifically, adding polymerized type liquid silicone rubber may preferably used in terms of smoothness, short-curing time, and less sub-polymerized matters, releasing property, and size-stability.

Specifically, dimethylpolysiloxane rubber may preferably used in terms of refractive index approximately around 1.43 of the cured resin because such master may be sued as a crud layer without releasing process form the substrate. In this case, the crud layer may be tightly formed onto the substrate. The liquid type silicone rubber may preferably having a viscosity from 500 to 7,000 mPa·s, more preferably having 2,000 to 5,000 mPa·s.

The master may have a surface energy form 10 dyn/cm to 30 dyn/cm, preferably 15 dyn/cm to 24 dyn/cm in terms of the fitness to the substrate. The share rubber hardness of the master may be 15 to 80, preferably 20 to 60. The surface roughness (R.M.S.) of the master may be less than 0.5 μm, preferably less than 0.1 μm.

The master may preferably have a light transmittance in a ultraviolet and visible light wavelength. If the master having a transparency in the visible light wavelength, in a preceding producing process or post producing process, process may be visibly monitored for example position detecting purpose of several elements for forming a optical waveguides. If the master having a transparency in the ultraviolet wavelength, curing UV light may be exposed to the curable resin for forming a core through the master having UV transparency. The transmittance of the master may preferably be more than 80% in a ultraviolet wavelength (250 nm to 400 nm).

(2) The process step will be described, in which a film substrate for a clad having good adhesiveness to the template is closely contacted with the template.

Because the optical waveguide of the invention can be used as a coupler, an optical wiring among boards, and an optical branching filter, the material of the film substrate is selected under consideration of the optical characteristics, such as the refractive index and the light transmittance, the mechanical strength, the heat resistance, the adhesiveness to the template and the flexibility of the material depending on the purpose thereof. It is preferred that a flexible film substrate is used to produce a polymer optical waveguide having flexibility. Examples of the film include an alicyclic acrylic film, an alicyclic olefin film, a cellulose triacetate film and a fluorine-containing resin film The refractive index of the film substrate is preferably 1.55 or less, and more preferably 1.53 or less, in order to assure the difference in refractive index from the core.

Examples of the alicyclic acrylic film OZ-1000 and OZ-1100, produced by Hitachi Chemical Co., Ltd., which is obtained by introducing an alicyclic hydrocarbon, such as tricyclodecane, into an ester substituent, can be used.

Examples of the alicyclic olefin film include those having a norbornene structure on the main chain, and those having a norbornene structure on the main chain and having a polar group, such as an alkyloxycarbonyl group (examples of the alkyl group include an alkyl group having from 1 to 6 carbon atoms and a cycloalkyl group), on the side chain. Among these, an alicyclic olefin resin having a norbornene structure on the main chain and having a polar group, such as an alkyloxycarbonyl group, on the side chain is suitable for producing a polymer optical waveguide of the invention because it has excellent optical characteristics, such as a low refractive index (about 1.50, by which the difference in refractive index the core from the clad can be assured) and a high light transmittance, is excellent in adhesiveness to the template, and is excellent in heat resistance.

The thickness of the film substrate is appropriately selected under consideration of flexibility, rigidity and easiness in handling, and in general, it is preferably in a range of about from 0.1 to 0.5 mm.

(3) The process step will be described, in which one end of the template having been closely contacted with the film substrate for a clad is contacted with an ultraviolet ray curable resin or a thermosetting resin to be a core, so as to fill the ultraviolet ray curable resin or the thermosetting resin in the depressions of the template by capillary phenomenon.

In this process step, the ultraviolet ray curable resin or the thermosetting resin is filled in the gaps (the depressions of the template) formed between the template and the film substrate by the capillary phenomenon, and therefore, it is necessary that the ultraviolet ray curable resin or the thermosetting resin used has a sufficiently low viscosity to enable such an operation, and the refractive index of the resin formed by curing the curable resins is higher than that of the polymer material constituting the clad (e.g., the difference from the clad is 0.02 or more). Furthermore, in order to reproduce the original shape of the depressions for forming the optical waveguide formed on the master with high accuracy, it is necessary that the volume change before and after curing of the curable resin is small. For example, reduction in volume causes loss in wave guiding. Therefore, the curable resin preferably shows small volume change, e.g., preferably 10% or less, and more preferably 6% or less. Reduction in viscosity by using a solvent is preferably avoided because it brings about large volume change before and after curing.

The viscosity of the curable resin is thus preferably from 10 to 2,000 mPa·s, more preferably from 20 to 1,000 mPa·s, and further preferably from 30 to 500 mPa·s.

Preferred examples of the ultraviolet ray curable resin include epoxy series, polyimide series and acrylic series ultraviolet ray curable resins.

In order to facilitate filling of the ultraviolet ray curable resin or the thermosetting resin in the depressions of the template by capillary phenomenon in such a manner that one end of the template having been closely contacted with the film substrate is contacted with the ultraviolet ray curable resin or the thermosetting resin to be a core, it is preferred that the whole system is placed in reduced pressure (e.g., about from 0.1 to 200 Pa). Instead of the whole system in reduced pressure, it is also possible that the other end than that being contacted with the curable resin is aspirated with a pump, and the end being contacted with the curable resin is pressurized.

Furthermore, in order to facilitate the filling, it is also an effective method that, instead of the depressurization and the pressurization, the curable resin contacting with the end of the template is heated to lower the viscosity of the curable resin.

The refractive index of a cured product of the ultraviolet ray curable resin or the thermosetting resin to be the core is necessarily larger than that of the film substrate to be a clad (including the clad layer referred in the following process step (5)), and is preferably 1.53 or more, and more preferably 1.55 or more. The difference in refractive index of the clad from the core (including the clad layer referred in the following process step (5)) is preferably 0.02 or more, and more preferably 0.05 or more.

(4) The process step will be described, in which the ultraviolet ray curable resin or the thermosetting resin thus filled is cured, and the template is released from the film substrate.

The ultraviolet ray curable resin or the thermosetting resin thus filled is cured In order to cure the ultraviolet ray curable resin, an ultraviolet ray lamp, an ultraviolet ray LED and other UV irradiation instruments are employed. In order to cure the thermosetting resin, heating, such as heating in an oven, is employed.

It is possible that the template used in the process steps (1) to (3) is used as the clad layer as it is, and in this case, the template is not necessarily released but can be utilized as the clad layer.

(5) The process step will be described, in which a clad layer is formed on the film substrate having cores formed thereon.

A clad layer is formed on the film substrate having the cores formed thereon. Examples of the clad layer include a film (for example, the film substrate used in the process step (2) can be similarly used), a layer formed by coating and curing a curable resin (such as an ultraviolet ray curable resin and a thermosetting resin), and a polymer film obtained by coating and drying a solvent solution of a polymer material. In the case where a film is used as the clad layer, they are laminated by using an adhesive, and it is preferred that the refractive index of the adhesive is close to the refractive index of the film.

The refractive index of the clad layer is preferably less than 1.55, and more preferably less than 1.53, in order to assure the difference in refractive index from the core. It is preferred from the standpoint of the containment of light that the refractive index of the clad layer is equalized to the refractive index of the film substrate.

In the process for producing a polymer optical waveguide according to the invention, such a combination is preferred that uses a thermosetting silicone resin, particularly a thermosetting dimethylsiloxane resin, as the material for the template, and an alicyclic olefin resin having a norbornene structure on the main chain and having a polar group, such as an alkyloxycarbonyl group, on the side chain as a film substrate. This is because the adhesiveness therebetween is particularly high, and thus the curable resin can be quickly filled in the depressions by the capillary phenomenon even when the cross sectional area of the depression structure is extremely small (for example squares of 10×10 μm).

Furthermore, the template can be used as the clad layer, and in this case, it is preferred that the refractive index of the template is 15 or less, and the template is subjected to an ozone treatment to improve the adhesiveness between the template and the core material.

### EXAMPLES

The invention will be described in more detail with reference to the examples below, but the invention is not construed as being limited to them.

### Example 1

A thick film resist (SU-8, produced by Microchemical, Inc.) is coated on an Si substrate by spin coating and is subjected to pre-baking at 80° C. The resist film is exposed through a photomask and is developed to form protrusions having square cross sections (width: 50 μm, height: 50 μm, length: 150 mm). The assembly is then subjected to post-baking at 120° C. to produce a master for producing a core of an optical waveguide.

A releasing agent is coated on the master, and then a thermosetting dimethylsiloxane rubber (SYLGARD 184, produced by Dow Corning Asia, Inc.) is cast thereon, followed by solidifying by heating to 120° C. for 30 minutes. The resin is then released to produce a template having depressions corresponding to the protrusions having square cross sections (thickness of the template: 3 mm). Both ends of the template are cut to form an inlet and an outlet for an ultraviolet ray curable resin described later, so as to complete the template.

The template is adhered to a film substrate having a size of slightly larger than the template and a thickness of 188 μm (Arton Film, produced by JSR Corp., refractive index: 1.510). Several droplets of an ultraviolet ray curable resin having a viscosity of 1,300 mPa·s (PJ3001, produced by JSR Corp.) are dropped on the inlet and outlet part on one end of the template, and thus the ultraviolet ray curable resin is filled in the depressions by the capillary phenomenon. The resin is irradiated with ultraviolet light of 50 mW/cm² for 5 minutes through the PDMS template to effect ultraviolet ray curing. The template is released from the Arton Film, and thus cores having the same shape as the protrusions formed on the master are formed on the Arton Film The cores have a refractive index of 1.591.

An ultraviolet ray curable resin (produced by JSR Corp.) having a refractive index after curing of 1.510, which is the same as that of the Arton Film, is coated on the whole surface of the Arton Film, on which the cores are formed, and is subjected to ultraviolet ray curing by irradiating with ultraviolet ray of 50 mW/cm² for 10 minutes (thickness after curing: 10 μm). As a result, a flexible polymer optical waveguide is obtained. The polymer optical waveguide exhibits a loss of 0.33 dB/cm.

### Example 2

A master for producing cores of optical waveguides having protrusions having square cross sections (width: 50 μm, height: 50 μm, length: 150 mm) is produced in the same manner as in Example 1. The template is produced in the same manner as in Example 1, and the template is finished by cutting both ends thereof. The template is adhered to Arton Film having a size of slightly larger than the template (thickness: 188 μm). Several droplets of thermosetting resin having a viscosity of 500 mpa·s (produced by JSR Corp.) are dropped on the inlet and outlet part on one end of the template, and thus the thermosetting resin is filled in the depressions by the capillary phenomenon. The resin is heated in an oven at 130° C. for 30 minutes to effect thermal curing. The template is released from the Arton Film, and thus cores having the same shape as the protrusions formed on the master are formed on the Arton Film. The cores have a refractive index of 1.560. Furthermore, a thermosetting resin (produced by JSR Corp.) having a refractive index after curing of 1.10, which is the same as that of the Arton Film, is coated on the whole surface of the Arton Film, and is subjected to thermal curing (thickness after curing: 10 μm). As a result, a flexible polymer optical waveguide is obtained. The polymer optical waveguide exhibits a loss of 0.33 dB/cm.

### Example 3

A master for producing cores of optical waveguides having protrusions having square cross sections (width: 50 μm, height: 50 μm length: 150 mm) is produced in the same manner as in Example 1. The template is produced in the same manner as in Example 1, and the template is finished by cutting both ends thereof. The template is adhered to Arton Film having a size of slightly larger than the template (thickness: 188 μm). Several droplets of an ultraviolet ray curable resin having a viscosity of 1,300 mPa·s (PJ3001, produced by JSR Corp.) are dropped on the inlet and outlet part on one end of the template. The assembly formed by adhering the template and the Arton Film is placed in a vessel depressurized (1.0 Pa) by a vacuum pump. The ultraviolet ray curable resin is then immediately filled in the depressions by the capillary phenomenon. Alter taken out the assembly from the vessel, it is subjected to curing by irradiating with ultraviolet light of 50 mW/cm² for 5 minutes through the PDMS template to curing, and then the template is released Cores having a refractive index of 1.591 are formed on the Arton Film.

Furthermore, an ultraviolet ray curable resin (produced by JSR Corp.) having a refractive index after curing of 1.510, which is the same as that of the Arton Film, is coated on the whole surface of the Arton Film, on which the cores are formed, and is subjected to ultraviolet ray curing by irradiating with ultraviolet ray of 50 mW/cm² for 5 minutes (thickness after curing: 10 μm). As a result, a flexible polymer optical waveguide is obtained. The polymer optical waveguide exhibits a loss of 0.33 dB/cm.

### Example 4

A flexible polymer optical waveguide is produced in the same manner as in Example 3 in which the template is adhered to the Arton Film and several droplets of the ultraviolet ray curable resin are dropped on the inlet and outlet part on one end of the template, except that the other end than the inlet and outlet part of the assembly of the template and the Arton Film is aspirated by a diaphragm aspiration pump (maximum aspiration pressure: 33.25 KPa) instead of the operation where the assembly is placed in the vessel depressurized by a vacuum pump. The polymer optical waveguide exhibits a loss of 0.33 dB/cm.

### Example 5

The process steps until cores are formed on the Arton Film are carried out in the same manner as in Example 1.

Another Arton Film (thickness: 188 μm) is adhered on the surface of the Arton Film, on which the cores are formed, by using an adhesive (produced by JSR Corp.) having a refractive index of 1.510, so as to produce a flexible polymer optical waveguide. The polymer optical waveguide exhibits a loss of 0.33 dB/cm.

### Example 6

A template is produced in the same manner as in Example 1. The template is adhered to Arton Film having a size of slightly larger than the template (thickness: 188 μm). Several droplets of an ultraviolet ray curable resin having a viscosity of 100 mPa·s (produced by NTT Advanced Technology Corp.) are dropped on the inlet and outlet part on one end of the template. The other end of the template than the inlet and outlet part is aspirated by a vacuum pump, and then the ultraviolet ray curable resin is filled in the depressions by the capillary phenomenon. The assembly is subjected to curing by irradiating with ultraviolet light of 50 mW/cm² for 5 minutes through the template to curing. The template is released from the Arton Film, and then cores having the same shape as the protrusions on the master are formed on the Arton Film. The refractive index of the cores is 1.570.

Another Arton Film (thickness: 188 μm) is adhered on the surface of the Arton Film, on which the cores are formed, by using an adhesive (produced by JSR Corp.) having a refractive index of 1.510, so as to produce a flexible polymer optical waveguide. The polymer optical waveguide exhibits a loss of 0.15 dB/cm.

### Example 7

A polymer optical waveguide is produced in the same manner as in Example 1 except for the following procedures. The ultraviolet ray curable resin is previously heated to 70° C., and several droplets thereof are dropped on the inlet and outlet part on one end of the template. After cooling to room temperature, the assembly is irradiated with an ultraviolet ray. The polymer optical waveguide exhibits a loss of 0.35 dB/cm.

According to the process for producing a polymer optical waveguide of the invention, the production process is highly simplified, and a polymer optical waveguide can be easily produced. Therefore, a polymer optical waveguide can be produced in a considerably low cost in comparison to the conventional processes for producing a polymer optical waveguide. Furthermore, according to the process for producing a polymer optical waveguide of the invention, such a flexible polymer optical waveguide can be obtained that has low transmission loss with high accuracy and is capable of being freely installed in various kinds of instruments. Moreover, the shape of the polymer optical waveguide can be freely configured.

The entire disclosure of Japanese Patent Application No. 2003-058872 filed on Mar. 5, 2003 including specification, claims, drawings and abstract is incorporated herein by reference in its entirety.

What is claimed is:

1. A process for producing a polymer optical waveguide comprising the steps of:
forming a layer of a resin material for forming a template on a master having protrusions for optical waveguides, releasing the layer to duplicate the master, and cutting both ends of the layer to expose depressions corresponding to the protrusions for optical waveguides, so as to produce a template;
closely contacting a film substrate as a clad having good adhesiveness to the template with the template;
contacting one end of the template with an ultraviolet ray curable resin or a thermosetting resin to be a core, so as to fill the ultraviolet ray curable resin or the thermosetting resin in the depressions of the template by capillary phenomenon;
curing the ultraviolet ray curable resin or the thermosetting resin thus filled, and releasing the template from the film substrate; and
forming a clad layer on the film substrate having cores formed thereon.

2. The process for producing a polymer optical waveguide as claimed in claim 1, wherein the clad layer is formed by coating and then curing an ultraviolet ray curable resin or a thermosetting resin.

3. The process for producing a polymer optical waveguide as claimed in claim 1, wherein the clad layer is formed by adhering a film for forming the clad with an adhesive having a refractive index close to that of the film.

4. The process for producing a polymer optical waveguide as claimed in claim 1, wherein the layer of the resin material for forming the template is a layer formed by curing a curable silicone resin.

5. The process for producing a polymer optical waveguide as claimed in claim 1, wherein the template has a surface energy of from 10 to 30 dyn/cm.

6. The process for producing a polymer optical waveguide as claimed in claim 1, wherein the template has a share rubber hardness of from 15 to 80.

7. The process for producing a polymer optical waveguide as claimed in claim 1, wherein the template has a surface roughness of 0.5 μm or less.

8. The process for producing a polymer optical waveguide as claimed in claim 1, wherein the template has a light transmittance of 80% or more in a wavelength region of from 350 to 700 nm.

9. The process for producing a polymer optical waveguide as claimed in claim 1, wherein the template has a thickness of from 0.1 to 50 mm.

10. The process for producing a polymer optical waveguide as claimed in claim 1, wherein the film substrate for a clad has a refractive index of 1.55 or less.

11. The process for producing a polymer optical waveguide as claimed in claim 1, wherein the film substrate for a clad is an alicyclic acrylic resin film.

12. The process for producing a polymer optical waveguide as claimed in claim 1, wherein the film substrate for a clad is an alicyclic olefin resin film.

13. The process for producing a polymer optical waveguide as claimed in claim 12, wherein the alicyclic olefin resin film is a resin film having a norbornene structure on the main chain and having a polar group on the side chain.

14. The process for producing a polymer optical waveguide as claimed in claim 1, wherein the step of charging the ultraviolet ray curable resin or the thermosetting resin in the depressions of the template by capillary phenomenon is carried out by depressurizing the whole system.

15. The process for producing a polymer optical waveguide as claimed in claim 1, wherein the ultraviolet ray curable resin or the thermosetting resin has a viscosity of from 10 to 2,000 mPa·s.

16. The process for producing a polymer optical waveguide as claimed in claim 1, wherein the ultraviolet may curable resin or the thermosetting resin shows volume change upon curing of 10% or less.

17. The process for producing a polymer optical waveguide as claimed in claim 1, wherein the clad layer has the same refractive index as that of the film substrate for a clad.

18. The process for producing a polymer optical waveguide as claimed in claim 1, wherein the cores have a diameter of from 10 to 500 μn.

19. The process for producing a polymer optical waveguide as claimed in claim 1, wherein a cured product of the ultraviolet ray curable resin or the thermosetting resin has a refractive index of 1.55 or more.

20. A process for producing a polymer optical waveguide comprising the steps of:
preparing a template formed from cured layer of curable resin, the template having a depression corresponding to a core portion of an expecting optical waveguide, an opening for filling a curable resin and an opening for expelling the curable resin;
closely contacting a film substrate as a clad having good adhesiveness to the template with the template;
contacting one end of the template with a curable resin to be a core, so as to fill the curable in the depression of the template by capillary phenomenon;
curing the curable resin, and releasing the template from the film substrate; and
forming a clad layer on the film substrate having cores formed thereon.
